(19) United States
(12) Patent Application Publication
(10) Pub. No.: US 2019/0258523 A1
(43) Pub. Date: Aug. 22, 2019

(54) Character-Driven Computing During Unengaged Time

(71) Applicant: Anki, Inc., San Francisco, CA (US)

(72) Inventors: Hanns W. Tappeiner, San Francisco, CA (US); Brad Neuman, San Francisco, CA (US); Andrew Neil Stein, San Francisco, CA (US); Jesse Easley, San Francisco, CA (US); David Mudie, San Francisco, CA (US); Troy Whitlock, San Francisco, CA (US)

(21) Appl. No.: 15/901,755

(22) Filed: Feb. 21, 2018

(51) Int. Cl. G06F 9/50

(52) U.S. Cl. CPC G06F 9/5027

(57) ABSTRACT

Methods, systems, and apparatus, including computer programs encoded on computer storage media, for using character-driven robots and other agents for volunteer computing and other unengaged time computing tasks. One of the robots is configured to execute instructions that cause the robot to receive one or more sensor inputs from one or more sensor subsystems. From the one or more sensor inputs, a prediction representing a likelihood of one or more users engaging with the robot over a particular subsequent time period is computed. If the computed prediction indicates that the robot is in an unengaged state, the robot selects one or more unengaged time computing tasks and performs the selected one or more unengaged time computing tasks.

### BACKGROUND

This specification relates to idle time computing.

Idle time computing, also sometimes referred to as cycle scavenging, refers to techniques for identifying and utilizing idle computing resources for various applications. Often, idle time computing tasks are run as low-priority tasks so as not to interfere with primary computing tasks.

Volunteer computing and grid computing are examples of idle time computing technologies that allow owners of Internet-connected computers, mostly personal computers and recently, some cellphones, to rent, donate, or sell their unused processing power to projects that require massive and/or distributed computing resources, e.g., cancer research, earthquake detection, cryptocurrency mining, etc.

Even though the number of computing devices worldwide is enormous, the amount of processor power devoted to idle time computing is tiny in practice. The current largest volunteer computing networks are thus able to utilize only a tiny fraction of the all the computing devices that are connected to the Internet.

Although idle time computing has real-world impacts and benefits, the lack of user participation stems in large part from a number of significant drawbacks that exist from a user's perspective.

First, users generally receive little to no incentive for participating. For example, with volunteer computing, the raw user desire to help a particular cause is often the only motivation for a user to participate. Volunteer computing applications also may not have consistent quality in the status that is reported back to the user.

Second, these psychological incentives are often poorly and inconsistently communicated. For example, some volunteer computing applications may provide feedback that is difficult to interpret or appreciate. Others may provide no feedback at all. Related, without visible incentives, users may forget about, uninstall, or otherwise not actively engage the applications going forward.

But perhaps the biggest problem with idle time computing from a user perspective is frequently competing demands by the idle time computing application and the user for computing resources. Volunteer computing in particular tends to involve very processor-intensive, and oftentimes storage-intensive, operations. If the volunteer computing application demands these resources at the wrong time, the existence of the volunteer computing application can become a major annoyance to the user, who then becomes even more unlikely to allow the application to run.

All of these problems make it difficult to convince users to use the processing power of their devices to their full potential and overall lead to low user uptake of these processes.

### SUMMARY

This specification describes how a system can provide character-driven agents, e.g., mobile robots, that facilitate user participation in and authorization of computing activities to be performed by the agent while the agent is in an unengaged state. In this specification, an unengaged state is an agent state in which the agent has computed a prediction that substantial user engagement is not likely to occur for a particular duration of time. For example, an agent might enter an unengaged state when no users are detected for a long period of time, e.g., when the agent is at an owner's home and owner of the agent is at work or school. As another example, an agent might enter an unengaged state when the agent detects that users are present but not engaging with the agent, e.g., when an owner of the agent is watching television rather than engaging with the agent. “Unengaged time” thus refers to time periods in which the agent is in an unengaged state. “Unengaged time computing” thus refers to computing tasks performed by the agent while in an unengaged state, which can include idle time computing tasks, e.g., volunteer computing tasks. User participation and computing throughput is increased through a variety of mechanisms.

Particular embodiments of the subject matter described in this specification can be implemented so as to realize one or more of the following advantages. Using character-driven agents provides a more intuitive and user-friendly computing layer that encourages users to make use of and keep using various unengaged time computing activities. This encouragement can result in an increase in overall computing throughput for large scale idle time computing projects, e.g., volunteer computing projects. And when the character driven aspects are pleasing to the user, this results in a virtuous cycle wherein that user is even more likely to desire that more of his or her devices participate in unengaged time computing. Leveraging such a computing layer may also create a “halo effect” around the user's perception of the device that does such computing, i.e. that the user anthropomorphizes the device—and therefore becomes more attached to it—where that user becomes aware—via the computing layer—that the device is engaged in worthwhile activities, both in the form of benevolent volunteer computing and in other forms of unengaged time computing, e.g., tasks that operate on the user's own files. In addition, a project distribution system that coordinates activities of the agents can provide load balancing for distributed idle time computing projects so that all projects get a fair share of computing time provided by the agents, or that “gamifies” participation and opens up further character-driven possibilities and perpetuates the virtuous cycle of participation. Users may also be more forgiving of the device generally, where they have goodwill built up toward the device because of their awareness of that device's participation in volunteer computing.

Additionally, because character-driven agents are generally in control of their own computational resources, the system can more accurately identify unengaged time. Unlike a shared resource like a laptop computer or mobile phone, for which heuristics have to be used to determine when then machine is idle, an intelligent agent controlling the entire CPU can determine that the agent is in an unengaged state. This can help prevent issues like memory thrashing, where resources may be used when a computer is actually in use. If the agent is equipped with other sensors, it may be able to detect other cases that are indicative of an unengaged state, e.g., lights being off, or having not seen any motion or people for some time.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system.

FIG. 2A is a flowchart of an example process for performing an unengaged time computing task.

FIG. 2B illustrates a mobile robot generating notifications.

FIG. 2C illustrates an example user interface presentation for an agent performing system maintenance tasks.

FIG. 2D illustrates another presentation for an agent performing system maintenance tasks.

FIG. 3A is a flowchart of an example process for encouraging the performance of volunteer computing activities.

FIG. 3B illustrates how a negative emotional aspect affects the appearance of a robot.

FIG. 3C illustrates actions by a robot performing volunteer computing tasks.

FIG. 4 illustrates an example robot.

Like reference numbers and designations in the various drawings indicate like elements.

### DETAILED DESCRIPTION

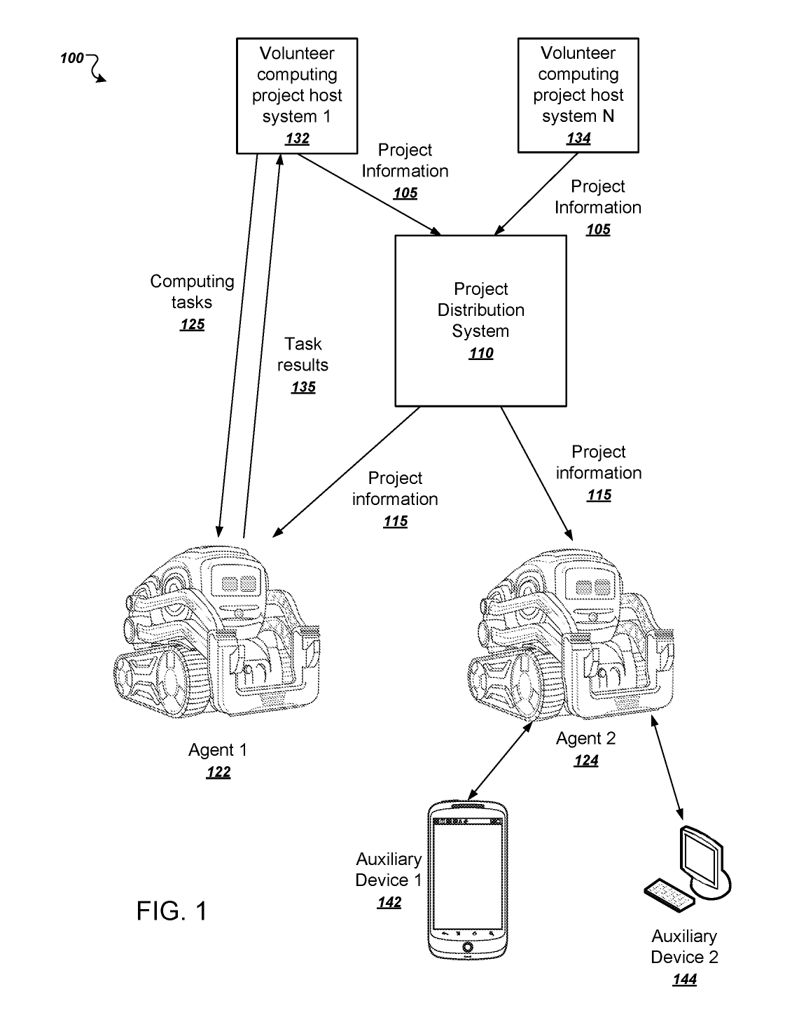

FIG. 1 is a diagram of an example system 100. The system 100 is an example system on which the techniques described in this specification can be implemented. The system includes two character-driven agents 122 and 124, a project distribution system 110, and two volunteer computing project host systems 132 and 134.

Each volunteer computing project host system 132 and 134, or, for brevity, host system, is a computer system that hosts a respective volunteer computing project. The volunteer computing project host systems 132 and 134 are examples of distributed idle time computing projects. Other distributed idle time computing projects that are not related to volunteer computing can also be used.

Each host system can receive requests by client devices to join the volunteer computing project. In response, the host system can provide software to be installed on the client device, or an interface such as through an API that the device accesses. After installation, the client devices can request volunteer computing tasks from the host system, perform the volunteer computing tasks, and provide the results back to the host system. Typically each host system is a distributed computing system running software installed on multiple computers in one or more locations. Because the host systems need to scale the computing process to multiple client devices potentially numbering into the thousands or millions, the host systems typically also have significant processing power.

The project distribution system 110 provides online services for each of the agents 122 and 124. In some implementations, the project distribution system is a distributed computing system having one or more computers.

In general, the project distribution system 110 can maintain a curated list of unengaged time computing tasks, e.g., volunteer computing projects, that can be provided to a population of agents. For example, the project distribution system 110 can provide data representing one or more unengaged time computing tasks, e.g., a library of unengaged time computing software code, that can be performed by each of the agents 122 and 124. Each unengaged time computing task defines particular operations for the agents 122 and 124 to perform which the agent is in an unengaged state. For example, one unengaged time task received from the project distribution system 110 can specify how a collection of digital images is to be catalogued or organized by the agent when the agent is in an unengaged state.

In the context of volunteer computing, maintaining a curated list of unengaged time computing tasks can include maintaining a curated list of volunteer computing projects that have been specifically approved by the project distribution system 110. This can ensure that the volunteer computing projects that are distributed to agents are actually meritorious projects rather than selfish or profit-seeking projects. Volunteer computing projects can apply to become part of the list curated by the project distribution system 110, which is advantageous because being on the list dramatically increases the computational throughput that is available to the volunteer computing projects, or projects may merit becoming part of the system by some metric, such as by usage on another network, user upvoting, or particular fit for the character-driven computing layer leveraged by the agents.

During or after being accepted by the application process, each host system 132 and 134 can provide project information 105, which is information that is sufficient for an agent to set up the software required to participate in the volunteer computing project. The project information 105 can for example identify one or more source or binary packages to be installed on the agents.

In some implementations, the project distribution system 110 can be controlled and operated by the manufacturer of the agents, in which case the agents can be configured by the project distribution system 110 to have integrated software capabilities for communicating with the project distribution system 110. Alternatively, the project distribution system 110 can be a third-party entity that agents connect with in order to discover unengaged time computing tasks distributed by other systems. Alternatively, such distribution system may be set up by a network administrator, who may be someone in a household or otherwise responsible for the devices on a particular network who may then have access to participate in the unengaged time computing activities.

The project distribution system 110 can maintain user profile information for users who own the agents 122 and 124, which can be used for matching unengaged time computing tasks. Matching generally involves identifying one or more unengaged time computing tasks that match the preferences of a user via recommendation techniques. For example, a user can answer a survey or directly edit an online profile to specify idle time computing projects of interest. Alternatively or in addition, the user can specify categories of causes or volunteer computing projects that the user is interested in participating in, e.g., cancer research, searching for extraterrestrial intelligence, or protein modeling, to name just a few examples. Or, if it is not the first time the user has participated in volunteer computing, the system may consider that user's engagement with the other projects as measured by the amount of volunteer computing that users' agent did previously, and finding projects more similar to those that were most engaged with. Alternatively, selection of computing projects could instead be completely random, or fixed without considering the user's input—for example, the list of projects may be in some order such as by an urgency assigned by the administrator based on external need and then distributed in order to the user's agent accordingly.

The project distribution system 110 distributes project information 115 to agents in a population of agents. The project information 115 can specify how to set up software to participate in an idle time computing tasks. The project information 115 provided by the project distribution system 110 may, but need not, be the same project information 105 provided by the host systems 132 and 134 to the project distribution system.

By distributing the project information 115 to agents in a population of agents, the project distribution system 110 can act as a load balancer for volunteer computing projects.

The project distribution system 110 can compute statistics representing how many agents are participating in each volunteer computing project in the curated list. Thus, if some volunteer computing projects are under-represented, the project distribution system 110 can perform load balancing by providing project information for the under-represented projects to agents in the population.

Each of the agents 122 and 124 is a character-driven agent. In this specification, a character-driven agent is a system that uses an internal state in order to determine how to communicate with users and to determine which actions to take. Character-driven agents are typically implemented by dedicated, standalone computing devices having one or more processors, memory, and integrated sensor subsystems, and network communication capabilities. For example, a character-driven agent can be a robot, an in-home assistant, or another standalone computing device. Many of the examples in this specification will refer to the character-driven agent as being a physical robot. Character-driven agents can also be implemented on any other appropriate standalone computing device. In this specification, the internal state used by character-driven agents will be referred to as an emotion state. The emotion state can be represented using a single-dimensional or a multi-dimensional data structure, e.g., a vector or an array, that maintains respective values for each of one or more different aspects. Each aspect can represent an enumerated value or a particular value on a simulated emotional spectrum, with each value for each aspect representing a location within that simulated emotional spectrum. For example, an example emotion state can have the following values: Happy, Calm, Brave, Confident, Excited, and Social, each of which may have a negative counterpart. The emotion states need not correspond to specifically identifiable human emotions. Rather, the emotion states can also represent other, more general or more specific spectrums that characterize agent behavior. For example, the emotion state can be a Social state that represents how eager the agent is to interact with users generally, a Want-To-Play state that represents how eager the agent is to engage in gameplay with a user, and a Winning state that represents how competitive the agent is in games. Emotion states can also correspond to current physical states of the agent, such as Needs-Repair and Low-Battery. Such states can manifest in the same sort of character and motion constraints as other emotion states.

The emotion state of a character-driven agent affects the behavior of the agent in a number of ways. First, the emotion state affects which animations are performed by the agent. In this specification, an animation is a group of one or more coordinated virtual or physical movements. An animation can thus also refer to data that encodes such movements and their coordination with each other, which will also be referred to simply as animations when the meaning is clear from context. In some instances, an animation also includes functions performed by other components that do not result in physical movement, e.g., electronic displays, lights, and sounds, to name just a few examples. Animations can be pre-generated animations that are human-designed, e.g., doing a happy dance, as well as procedural animations that are generated at runtime, e.g., driving around a new obstacle. Secondly, the emotion state can also affect how the animations are performed. For example, if the emotion state represents happiness, the robot can perform animations more briskly than if the emotion state represents sadness. In some implementations, the system can use machine learned models to map a multi-dimensional emotion state to either an animation to be performed, parameters for how the animation should be performed, or some combination of these.

After receiving project information 115 from the project distribution system 110, each agent can communicate directly with a host system to obtain volunteer computing tasks and to provide the results of such tasks. Computing tasks may be represented as precompiled executables, interpreted scripts, or script fragments to be executed by the agent. For example, the agent 122 receives computing tasks 125 from host system 132 and in response, provides task results 135 back to the host system 132.

Each agent can also employ other auxiliary computing devices alternatively or in addition to performing the computing tasks itself. In a typical scenario, an agent is connected to the same network as several other internet-connected devices, which can include any appropriate computing devices, desktop computers, laptop computers, tablet computers, smartphones, mobile consumer robots, in-home assistants, televisions, and streaming media devices, to name just a few examples. In the example of FIG. 1, the agent 124 is in communication with both a mobile phone auxiliary device 142 and a desktop computer auxiliary device 144. This is often the case in a home environment, for example, in which case users typically own many internet connected devices that could also be leveraged for unengaged time computing. Naturally, the user needs to configure each of the auxiliary devices to be utilized as an auxiliary unengaged time computing device, e.g., by installing mobile or desktop applications that configure the auxiliary devices to take instructions from an agent or by toggling a setting on the auxiliary device or in their management interface for such device (e.g. their WiFi router). After being set up, the agent can automatically instruct the auxiliary devices regarding unengaged time computing tasks that the auxiliary devices should participate in. Notably, the agent can automatically change the roster of such active unengaged time computing tasks. After being configured to participate in one or more unengaged time computing tasks, the auxiliary devices can communicate directly with the host systems or communicate through the agent in order to receive computing tasks and provide task results.

Although it would be theoretically possible to configure the auxiliary devices to communicate with the project distribution system 110, the character-driven aspects of the agent act as a more human-friendly layer on top of the unengaged time computing activities that encourage users to enable unengaged time computing and to keep such unengaged computing activities enabled.

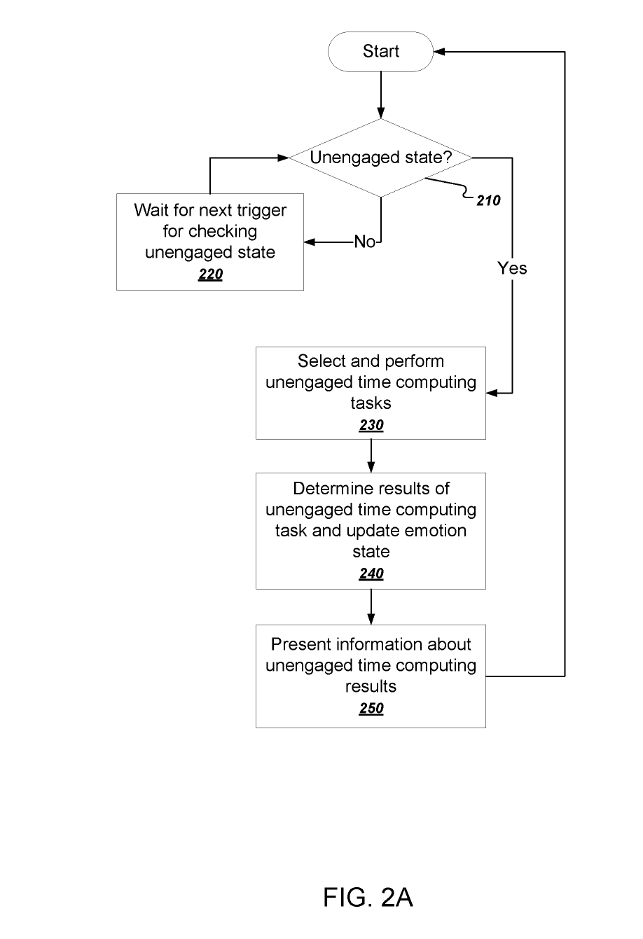

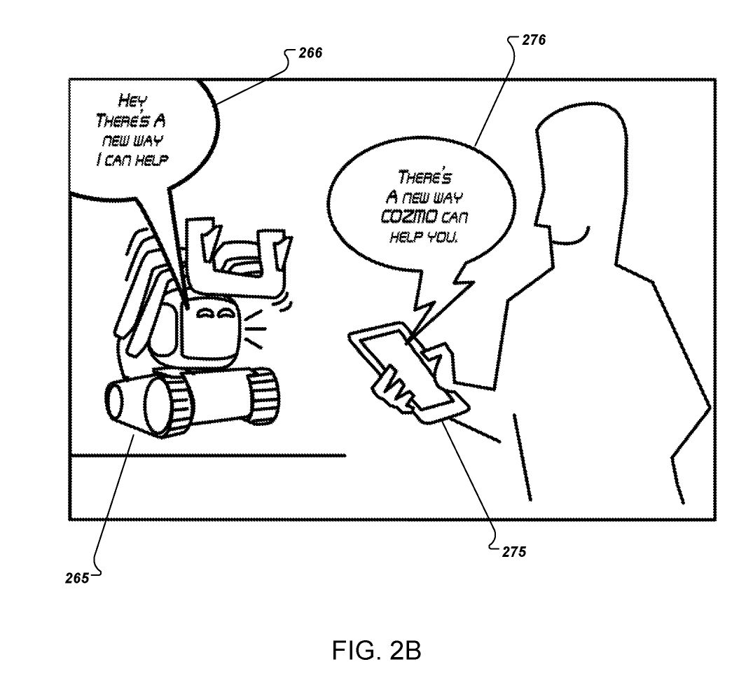

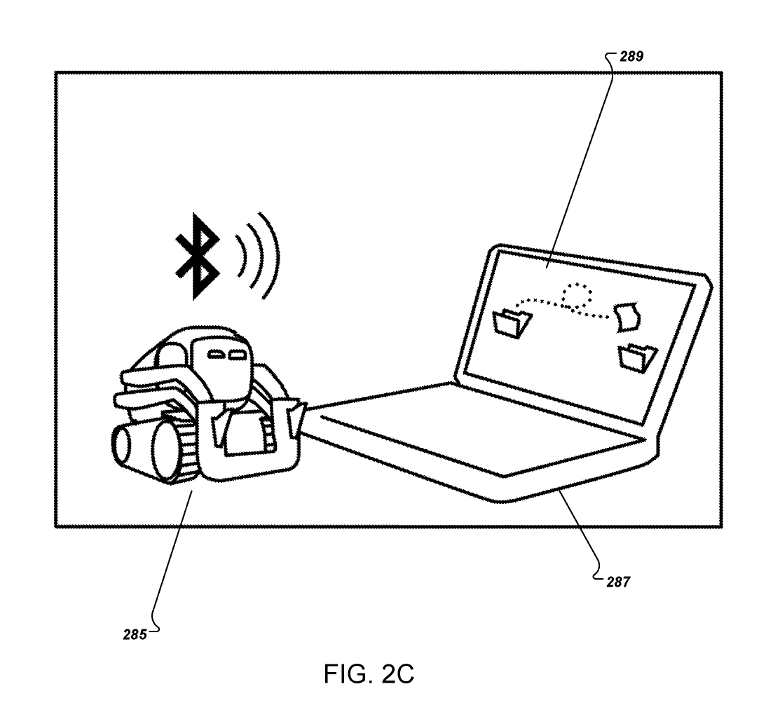

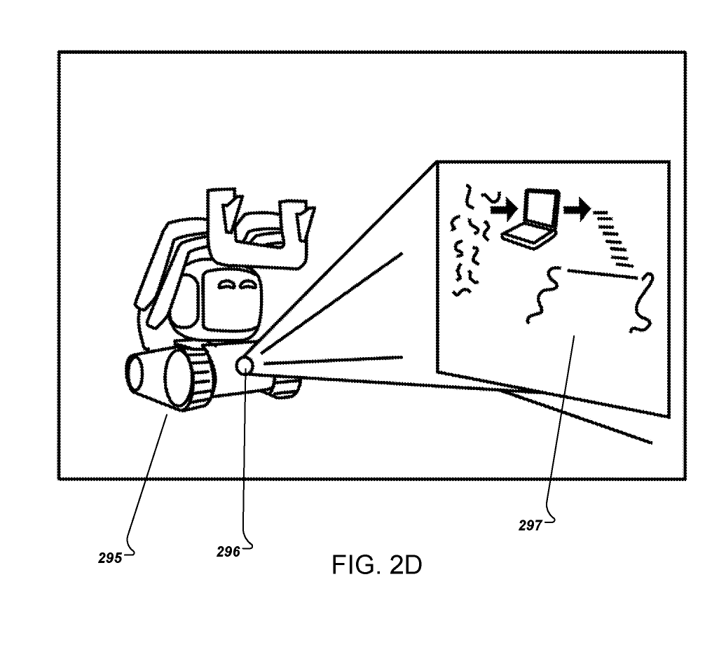

FIG. 2A is a flowchart of an example process for performing an unengaged time computing task. Character-driven agents and agents having integrated sensors have particular advantages over laptop and desktop computers in recognizing unengaged time. The process will be described as being performed by an agent programmed appropriately in accordance with this specification. For example, the agent 122 of FIG. 1, appropriately programmed, can perform the example process.

The agent determines whether or not the agent has entered an unengaged state (210). In other words, the agent can attempt to establish that the time is appropriate to perform unengaged time computing tasks. In this context, an unengaged state for a character-driven agent means a particular time period during which no substantial user interaction is predicted to occur. As described above, one of the user annoyances with traditional idle time computing tasks is that such tasks can introduce competing demands for computer resources at inopportune times, or must be actively engaged by the user who doesn't remember or doesn't have motivation to do so.

Agents having integrated, always-on sensors have advantages over traditional computing devices like laptops and desktop computers for determining whether or not they have entered an unengaged state. Therefore, the agent can use one or more sensor inputs to compute a prediction of user engagement with the robot over a particular subsequent time period, e.g., the next 1, 10, or 100 minutes. The prediction can be expressed in any appropriate format, e.g., as a probability, a likelihood, or a score, that represents a degree to which user engagement with the robot is predicted to occur. As time goes on without users engaging with the robot, the prediction tends to be more certain that users will not engage with the robot. On the other hand, if users are actively engaging with the robot, the prediction will indicate that the robot remains engaged rather than unengaged.

In some implementations, the agent determines whether or not the agent has entered an unengaged state by attempting to detect nearby users. The agent can use a variety of technologies for determining if users are nearby, e.g., by using face detection techniques, object detection techniques, and sound detection techniques, to name just a few examples. Suitable techniques for using integrated sensors to determine when users are paying attention to a robot are described in commonly owned U.S. patent application Ser. No. 15/694,710, to “Robot Attention Detection,” which is herein incorporated by reference. If no users are present or paying attention to the agent or interacting with the agent for at least a threshold amount of time, the agent can determine that the agent has entered an unengaged state.

Alternatively or in addition, the agent can leverage its emotion state to determine when the agent has entered an unengaged state. For example, some emotion states can represent emotional aspects of boredom, and if an agent becomes sufficiently bored, the agent can determine, based at least on the emotion state, that the agent has entered an unengaged state.

Thus, even if users are present but not paying attention to the robot, e.g., if the users are watching television, the robot's internal emotion engine can update the emotion state to have values that represent boredom. The boredom emotional aspect may or may not be explicitly represented as a value in the internal emotion state data structure. For example, a boredom emotional state can also arise due to a combination of emotion states representing sadness, restlessness, or both.

In some implementations, the agent can use a machine-learned model to determine when the robot's sensor subsystem inputs should be interpreted as being in an unengaged state. For example, a computing system can train a machine learning model with training data labeled with different values for the emotion state and whether or not such values indicate that the robot is in an unengaged state. After training the model, the system can install the model on the agent, and the agent can periodically classify the emotion state as indicating an unengaged state or not.

The agent can also use its location within its environment or other features of the environment to determine that the agent has entered an unengaged state. For example, if the agent is a mobile robot that is currently sitting on its charger, there is a high likelihood that the robot is in an unengaged state. As another example, if the agent is in a darkened room, e.g., a closet, the agent can determine that is in an unengaged state.

These mechanisms all address the user annoyance problem of traditional idle time computing tasks generally. They ensure that the agent performs such tasks only when they are unlikely to compete for computing resources requested by a user.

In some implementations, a mobile agent can automatically reconnect to a power supply, e.g., a charging station, before beginning unengaged time computing tasks. Thus, if the agent determines that it is available to perform unengaged time computing tasks, the agent also makes a determination of whether or not it has yet successfully returned to a power supply. For example, a robot can automatically navigate back to a charging station. Upon successfully initiating a charge, the robot can determine that it has entered an unengaged state.

If the agent is not in an unengaged state (210), the agent can wait for a next trigger for checking for an unengaged state (branch to 220). For example, the agent can intermittently or at periodic intervals determine whether or not the agent is in an unengaged state. The agent can also check whether an unengaged state has been entered due to a change in emotion state, a change in users or objects that are detected, or some combination of these.

If the agent is in an unengaged state (210), the agent selects and performs one or more unengaged time computing tasks (230). The agent can select the unengaged time computing tasks from a library of tasks using user preferences or previous user commands.

In some implementations, the agent generates a notification that communicates the capabilities of the agent to perform unengaged time computing. The agent can generate such notifications when new unengaged time computing tasks become available or when nearby users are detected, for example.

FIG. 2B illustrates a mobile robot 265 generating notifications. As a first example, the robot 265 can generate an audio or visual notification 266 that informs the user of new ways that the robot 265 can help the user by performing unengaged time computing tasks. Alternatively or in addition, the robot 265 can also generate a notification that is presented on a user device 275 of the user. The notification 276 can be, for example, an audio or visual presentation on the user device 275 that is presented by a locally installed application in communication with the robot 265.

There are number of different types of unengaged time computing tasks that can be performed by a character-driven agent.

As described above, one type of unengaged time computing task is volunteer computing in which the agent communicates directly with a project host system in order to obtain tasks to compute. An agent can also perform unengaged time tasks that require the agent to participate in large scale distributed systems, e.g., by performing a search for large prime numbers or performing resource-intensive blockchain operations or cryptocurrency mining operations, e.g., Bitcoin, Ethereum, or any other appropriate cryptocurrency mining operations.

Another type of unengaged time computing task is preprocessing of time-consuming user tasks. For example, the agent can receive a list of files to be downloaded and download files so that user can access them later, e.g., pre-downloading new episodes of a TV series.

As another example, the agent can organize the user's files in a shared network. For example, the agent can access a collection of photos and organize the photos by one or more particular attributes, e.g., location taken, tags, or people in the photos, to name just a few examples; detect and report duplicate photos or files; and detect and report corrupted or damaged photos or files.

Another types of unengaged time computing task is computationally intensive tasks. For example, the agent can perform computationally intense machine learning tasks, e.g., by receiving a training set and computing parameters of a machine learning model. The machine learning model can be any appropriate machine-learning model, e.g., neural networks or support vector machines. The agent can also perform computationally intensive tasks on local observations made by the agent in the agent's environment. For example, the agent can perform bundle adjustment for SLAM or visual structure-from-motion algorithms. These processes use a number of observations over a particular time window to refine a map of the agent's environment in order to best take all the observations into account at once.

Another type of unengaged time computing task is system maintenance tasks. These types of tasks aim to perform maintenance on the user's network. Maintenance can include running virus scans, cleaning out temporary or unnecessary files, or performing health checkups, e.g., probing a home network for vulnerabilities.

FIG. 2C illustrates an example user interface presentation for an agent performing system maintenance tasks. In this example, a robot 285 is communicating wirelessly with a laptop computer 287 while performing unengaged time system maintenance tasks. While the robot 285 directs these activities, the laptop computer 287 generates a user interface presentation 289 that graphically illustrates the progress of the system maintenance activities. In this case, the user interface presentation 289 illustrates that files are being reorganized from one folder to another.

FIG. 2D illustrates another presentation for an agent performing system maintenance tasks. In this example, a robot 295 is equipped with projector hardware 296 that is capable of projecting a presentation 297 onto a flat surface. In this example, the robot 295 also directs the organization of files on a user's laptop computer, but the robot 295 need not use the screen of the laptop to display the presentation 297.

Other types of unengaged time computing tasks are tasks that relate to exploring and building representations of the agent's environment. These activities can include physically navigating around the environment to build a map of the environment, e.g., by discovering walls, boundaries, and doors within the environment. These activities can also include physically navigating around the environment to build representations of acoustic transfer functions between points within the environment of the robot. Such acoustic transfer functions can be used to enhance the audio that the agent receives at any location within the environment.

The agent determines the results of the unengaged time computing task and updates its emotion state (240). The agent can use the outcome of the unengaged time computing task to affect one or more aspects of the emotion state. For example, if the unengaged time task was successful, the agent can update its emotion state to appear happier, while if the unengaged time task was unsuccessful, the agent can update its emotion state to appear sadder.

By updating the emotion state in accordance with the results of the unengaged-time computing tasks, a character-driven agent becomes more lifelike, more interactive, and easier to use. This process also encourages users to trust the agent to do more unengaged time computing tasks because the user receives readily understandable feedback about such tasks.

The agent presents information about the results of the unengaged time computing task (250). The agent can present the information at a particular triggered time, a time that can be determined in a similar way as described above, e.g., after a long user absence or in response to an inquiry from the user. For example, the user can ask, “What did you work on today?” or “How did you help today?” In response to these kinds of triggering questions, the agent can provide information about the unengaged time computing results in any appropriate presentation format, e.g., verbally, by electronic display, or by electronic message.

As another example, in the case of building a map of the environment of the robot, the robot can continually encourage the user to allow the robot to build the map when the robot is unengaged. After performing these activities while the user is away, the robot can report to the user all of the things that were done as well as information about why they matter. For example, if the robot built an acoustic representation of the environment, the robot can present information to the user indicating that the robot's speech recognition skills should be substantially enhanced by allowing such useful unengaged time computing tasks.

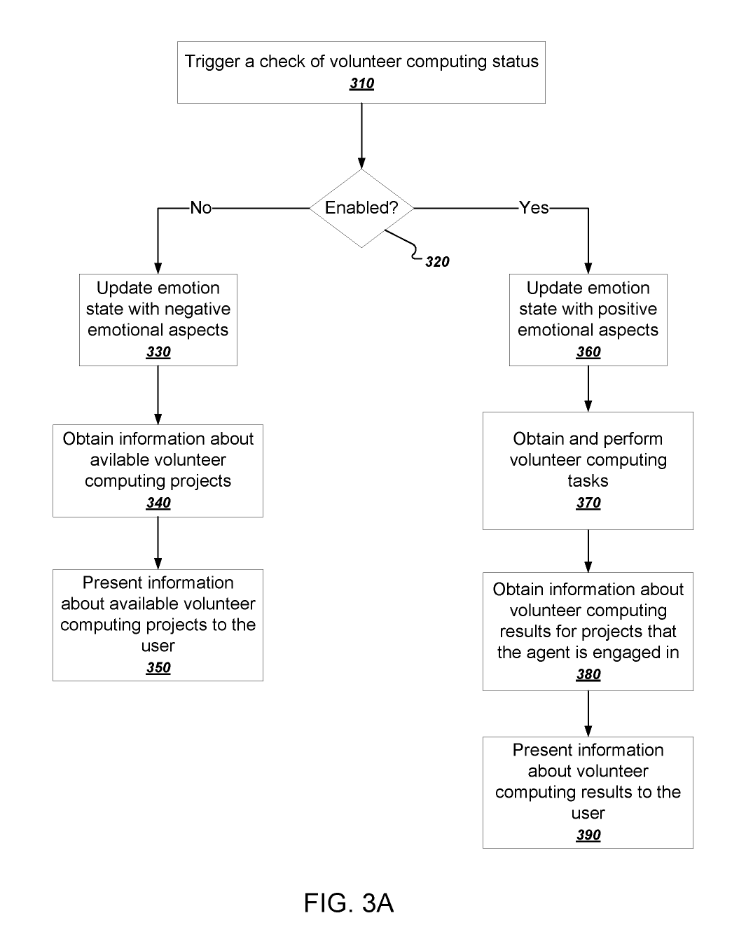

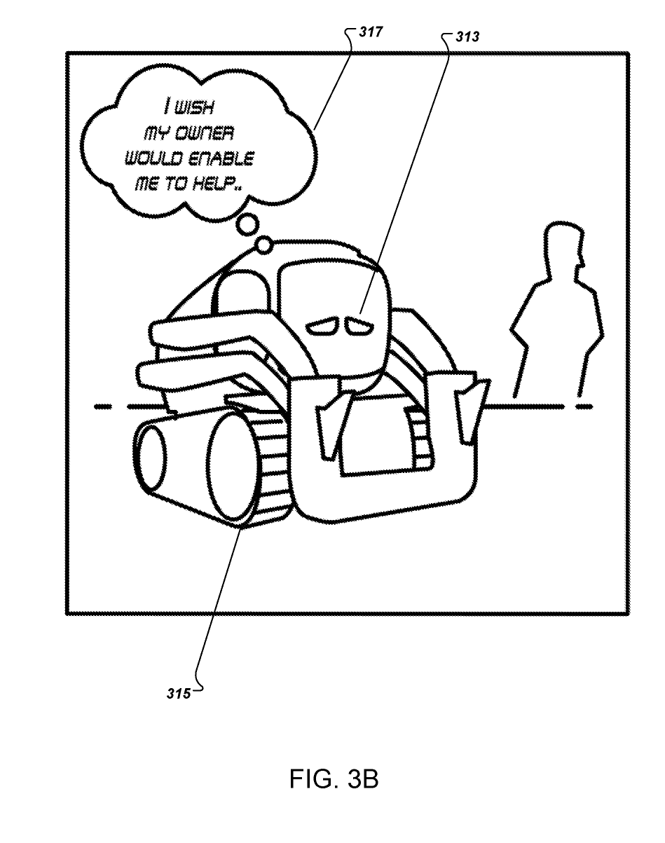

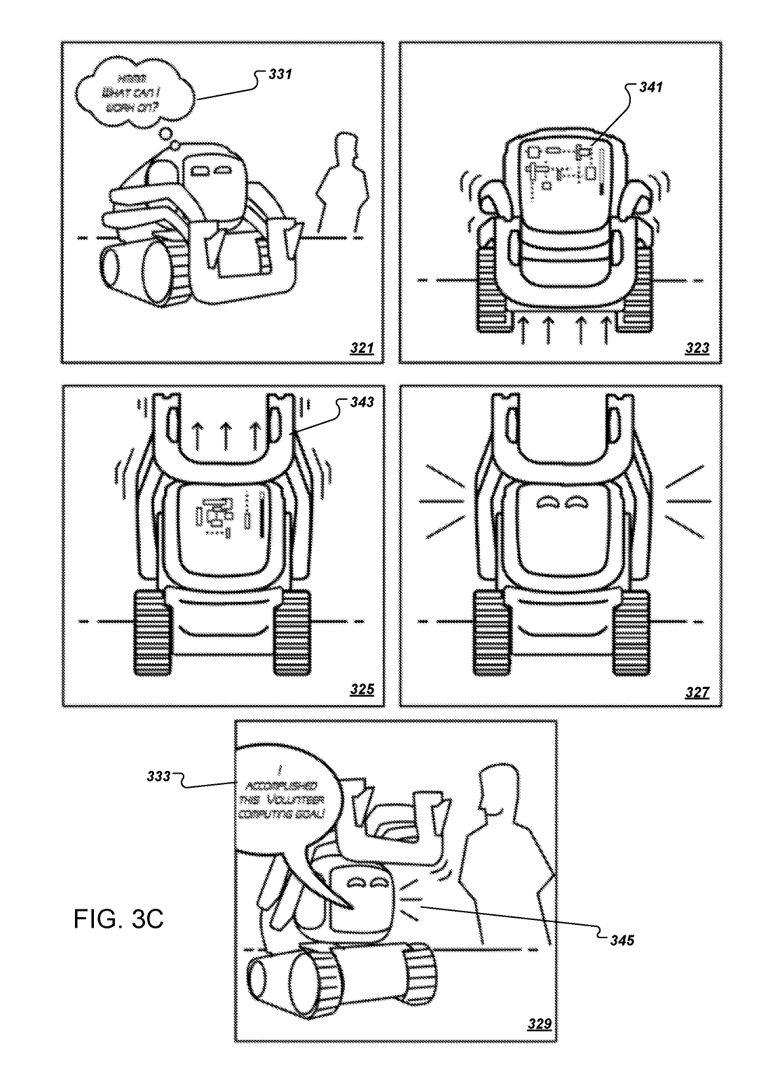

FIG. 3A is a flowchart of an example process for encouraging the performance of volunteer computing activities. The process will be described as being performed by an agent programmed appropriately in accordance with this specification. For example, the agent 122 of FIG. 1, appropriately programmed, can perform the example process.

The agent triggers a check of its volunteer computing status (310). The volunteer computing status represents whether or not the owner of the agent has enabled volunteer computing by the agent or by one or more other computing devices. The volunteer computing status can also represent which volunteer computing projects or which volunteer computing project categories the user has assigned the agent to work on.

The agent can trigger a check of the volunteer computing status intermittently or at periodic intervals. The agent can also trigger a check of the volunteer computing status due to inactivity, the lack of presence of users, an emotion state representing boredom, an explicit command by a user, the connection of a new auxiliary device to the network that the agent is on, or some combination of these. For example, the agent could use a discovery protocol to detect when the user installs a volunteer computing application on a laptop computer. As another example, the agent could detect when a computing device with capabilities for volunteer computing is added to the network.

The agent determines if volunteer computing is enabled (320). This determination can be per-device setting or a global setting for multiple agents. For example, volunteer computing can be enabled for a mobile robot, but not for a desktop computer. If volunteer computing is not enabled, the agent updates the emotion state with one or more negative emotional aspects (330). The negative emotional aspects are emotional aspects associated with unpleasantness, which can include aspects such as sadness, irritability, impatience, or sickness, to name just a few examples. The agent can increase the representative values of such negative emotional aspects or equivalently decrease the representative values of corresponding positive emotional aspects.

After updating the emotion state, communications and interactions with users will be affected. For example, the agent can select to perform precomputed or procedural animations that are more associated with the negative emotional aspects. This can, for example, cause a robot to drive slower, talk slower, and mope.

FIG. 3B illustrates how a negative emotional aspect affects the appearance of a robot. The state of the robot 315 can result, for example, from a user turning off automatic volunteer computing, or forgetting or refusing to enable volunteer computing on the robot 315. As a result, the robot 315 updates its emotion state with negative emotional aspects, which can be outwardly observed. For example, the robot 315 can display simulated sad eyes 313 on an electronic display of the robot 315. The robot can also issue a message 317 that communicates why the robot is in the current emotion state. The message 317 can be an audio or visual presentation by the robot, e.g., spoken by the robot 315. Alternatively or in addition, the robot 315 can electronically communicate the message 317 to the user, e.g., by email or text message.

The agent can then obtain information about available volunteer computing projects (340). For example, the agent can communicate with a project distribution system that provides information about available volunteer computing projects. If the user has specified preferences about categories of volunteer computing, the agent can access the user preferences and request information about projects in the specified volunteer computing categories.

The agent can then present information about the available volunteer computing projects to the user (350). In general, the agent can communicate information on the existence and availability of volunteer computing projects at a particular triggered time. In this way, the agent acts as a discovery mechanism that allows the user to effortlessly obtain information that the user would have otherwise had to search for. In other words, the user can be made aware of new projects and causes in different categories.

The discovery of new projects in different causes has an aggregate load balancing effect on the volunteer computing projects. This addresses another problem with volunteer computing in general, which is that only a few of the most popular projects get any computing power. By providing an automatic, character-driving discovery mechanism, the agents work together to help load balancing computing resources across all volunteer computing projects.

The presentation of information can take a variety of forms. For example, the agent can simply use a text-to-speech engine to verbally present the information to the user. The agent can also use an integrated or communicatively coupled electronic display to present the information to the user. Alternatively or in addition, the agent can send an electronic message containing the information, e.g., a text message, an email message, or any other appropriate electronic message.

The agent can present the information due to a variety of triggers. For example, the agent can be triggered upon seeing a user after an extended absence. This may correspond to the agent seeing the user in the morning or when the user comes home from work or school or another appointment.

As another example, the agent can detect one or more verbal triggers. For example, the agent can present the information upon the user inquiring about the state of the agent, e.g., “How was your day?” or “Why are you sad?” The agent can then present further information regarding the benefits of participating in worthwhile volunteer computing projects and that the agent would feel better if the user would agree to participate.

In this way, the character-related aspects of the agent guide the user toward enabling volunteer computing. Although in any individual case the results are somewhat unpredictable, at scale these processes may result in vast increases in the computing throughout available to volunteer computing projects.

If, on the other hand, volunteer computing was enabled (320), the agent can update the emotion state with positive emotional aspects (360). The positive emotional aspects are emotional aspects associated with pleasantness, which can include aspects such as happiness, contentedness, silliness, playfulness, or sociability, to name just a few examples. The agent can increase the representative values of such positive emotional aspects or equivalently decrease the representative values of corresponding negative emotional aspects.

The update to the emotion state will affect how the agent behaves and communicates with users. The update to the emotion state will also affect the precomputed or procedural animations that the agent selects to perform. This can, for example, cause a robot drive fast, talk faster, and laugh.

In some implementations, a sufficient bump in positive emotional aspects due to volunteer computing can unlock an additional capability on the agent. For example, an agent can intermittently communicate its current emotion state to an online services system, e.g., the project distribution system 110 of FIG. 1. If the emotion state reflects a certain level of positive emotional aspects due to participation in volunteer computing, the online services system can provide to the agent a new animation that the agent could not previously perform. For example, the animation can be a happy dance or a song about volunteer computing.

Such incentives also have network effects because users may share their newly unlocked capabilities with their friends, which further encourages such friends to also enable their agents to participate in volunteer computing. The network effects can be additionally enhanced by the online services system providing new capabilities upon certain community goals being reached. For example, agents can join teams, and the system can reward each agent in a team for reaching particular milestones. The rewards can also be global among all agents in the system. For example, if 1 million agents participate in a given week, the system can unlock new capabilities for all agents that participated. Additional incentives can include publically available leaderboards that indicate which agents donated the most time, recruited the most other agents, or utilized the most auxiliary devices, to name just a few examples.

This solves yet another preexisting problem with volunteer computing, which is the lack of a reward for the end user. But by having a character-driven agent involved in the process, the user may find the agent more engaged, playful, and more fun when the agent is dedicating processing time to volunteer computing projects.

The agent obtains and performs volunteer computing tasks (370). The agent can obtain the volunteer computing tasks directly from each respective volunteer computing project system. Alternatively or in addition, the agent can receive volunteer computing tasks through a project distributing system.

Before performing the tasks, the agent can first establish that the time is appropriate to perform volunteer computing tasks. As described above, one of the user annoyances with volunteer computing projects is that volunteer computing tasks can introduce competing demands for computer resources at inopportune times. Agents having integrated sensors have advantages over traditional computing devices like laptops and desktop computers for determining opportune times to perform volunteer computing tasks.

In some implementations, the agent determines its availability to perform volunteer computing tasks by attempting to detect nearby users. The agent can use a variety of technologies for determining if users are nearby, e.g., by using face detection techniques, object detection techniques, and sound detection techniques, to name just a few examples. Suitable techniques for using integrated sensors to determine when users are paying attention to a robot are described in commonly owned U.S. patent application Ser. No. 15/694,710, to “Robot Attention Detection,” which is herein incorporated by reference.

If no users are present or paying attention to the agent or interacting with the agent for at least a threshold amount of time, the agent can begin performing volunteer computing tasks and reporting the results of the tasks back to the volunteer computing project systems.

In some implementations, the agent can automatically return to a charging station before beginning volunteer computing tasks. Thus, if the agent determines that it is available to perform volunteer computing tasks, the agent also makes a determination of whether or not it has yet successfully returned to its charging station. For example, a robot can automatically navigate back to a charging station. Upon successfully initiating a charge, the robot can begin performing volunteer computing tasks.

Alternatively or in addition, the agent can leverage the emotion state to determine when to perform volunteer computing tasks. For example some emotion states can represent emotional aspects of boredom, and if an agent becomes sufficiently bored, the agent can begin performing volunteer computing tasks.

Thus, even if users are present but not paying attention to the robot, e.g., if the users are watching television, the robot's internal emotion engine can update the emotion state to have values that represent boredom. The boredom emotional aspect may or may not be explicitly represented as a value in the internal emotion state data structure. For example, a boredom state can also arise due to a combination of being sad and restless. In some implementations, the agent can use a machine-learned model to determine when the robot is sufficiently bored to perform volunteer computing tasks. For example, a computing system can train a machine learning model with training data labeled with different values for the emotion state and whether or not such values indicate that the robot should perform volunteer computing tasks. After training the model, the system can install the model on the agent, and the agent can periodically classify the emotion state as a state indicating that the robot should perform volunteer computing tasks.

These mechanisms all address the user annoyance problem of volunteer computing generally. They ensure that the agent performs volunteer computing tasks only when they are unlikely to compete for computing resources requested by the user. This in turn has the effect of the user keeping the volunteer computing features enabled.

In some implementations, the agent performs the volunteer computing tasks only after the agent has entered an unengaged state. Techniques for determining when the agent has entered an unengaged state are described in more detail above with reference to FIG. 2.

After performing volunteer computing tasks, the agent can also optionally update the emotion state again with positive emotional aspects to simulate the agent feeling good about donating its processing power to good causes. As described above, these updates can cause the agent to act happier, more social, or more talkative.

As part of the process of performing volunteer computing tasks, the agent can also recruit and employ auxiliary computing devices. For example, the agent can use an appropriate discovery protocol to discover one or more Internet-enabled devices that are also controlled by the user. Alternatively or in addition, the agent can prompt the user to specify the network addresses of such devices directly. The agent can then occasionally ask the user to enable such devices by installing software that allows the agent to control which volunteer computing projects the auxiliary devices participate in.

Because employing auxiliary devices can greatly explode the number of available devices, the agent can also additionally update its emotion state with further positive emotions if the user agrees to donate time on auxiliary devices. This provides a further incentive for the user to agree to use such devices. In addition, each milestone of auxiliary devices utilized, e.g., 1 device, 2 devices, 10 devices, etc., can unlock additional capabilities and animations for the agent.

The agent can then obtain information about the results of volunteer computing projects that the agent is engaged in (380). In some cases, the results of the volunteer computing projects can be obtained simply as locally maintained statistics. For example, if the agent is involved in gene sequencing, the agent can provide information about the types and number of genes that were sequenced recently. In other cases, the agent can obtain the information by communicating with a volunteer computing project system, which can provide the agent with aggregated statistics about the project as a whole or information that is easier to digest or understand. For example, the information can indicate that the agent was part of a total of 4 million genes were sequenced across all agents worldwide.

The agent can then present information about the volunteer computing results to the user (390). The agent can communicate this information at a particular triggered time in a similar way that the results of unengaged time computing tasks are presented to users, as described above with reference to FIG. 2. In this way, the character-related aspects of the agent help to keep the user apprised of the volunteer computing project and help to keep the user interested. These effects are significant on a large scale, and in turn increase the computing power available to volunteer computing projects.

FIG. 3C illustrates actions by a robot performing volunteer computing tasks. The five panels 321, 323, 325, 327, and 329, illustrate different stages of the process.

In panel 321, a robot generates a presentation indicating its ability to perform volunteer computing tasks. In this example, the robot can generate an audio or visual presentation to communicate the message 331. This can happen, for example, when nearby users are present.

In panel 323, the robot begins performing a volunteer computing task. While performing the task, the robot can indicate its progress in a number of ways. As one example, the robot can generate a live feedback presentation 341 on an electronic display that indicates that the volunteer computing task is ongoing, and optionally, how far along the task is.

As another example, as shown across panels 323, 325, and 327, the robot can physically move one of its components as a visual representation of the task progress. In this example, the robot moves its lift 343 at a angle corresponding to the progress of the robot performing the volunteer computing task. The lift 343 being at its maximum height, as shown in panel 327 indicates that the volunteer computing task is completed.

At that point, as shown in panel 329, the robot can communicate a message 333 to a user, e.g., when the user returns within the vicinity of the robot. The robot can also indicate the status of the volunteer computing tasks with a presentation 345 on an electronic display, or by a physical representation, e.g., by moving its lift to a fully raised position.

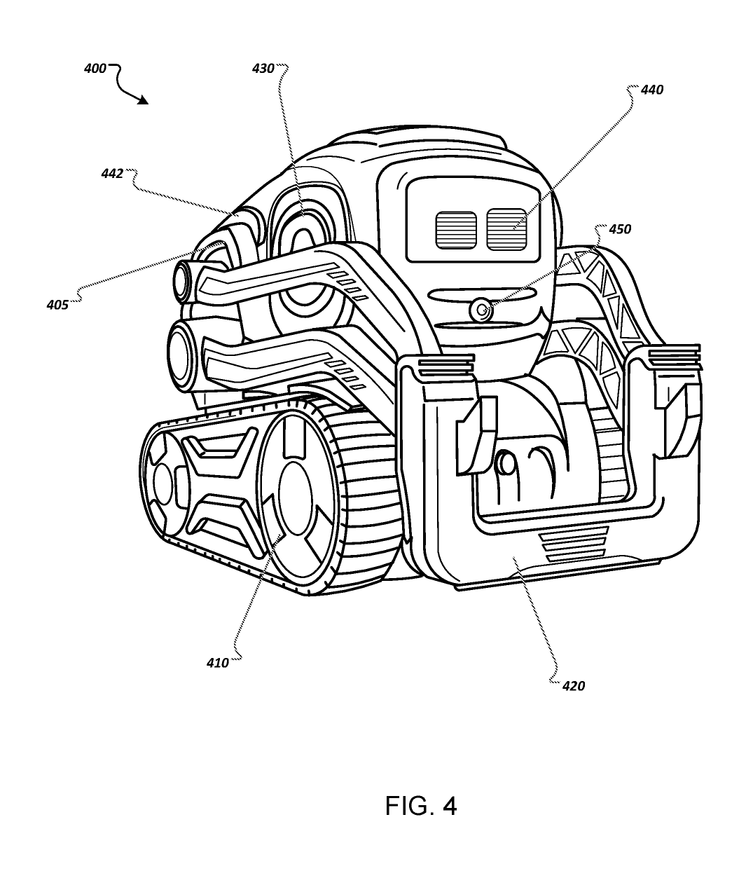

FIG. 4 illustrates an example robot 400. The robot 400 is an example of a mobile autonomous robotic system that can serve as a character-driven agent for implementing the techniques described in this specification. The robot 400 can use the techniques described above for use as a toy or as a personal companion.

The robot 400 generally includes a body 405 and a number of physically moveable components. The components of the robot 400 can house data processing hardware and control hardware of the robot. The physically moveable components of the robot 400 include a propulsion system 410, a lift 420, and a head 430.

The robot 400 also includes integrated output and input subsystems.

The output subsystems can include control subsystems that cause physical movements of robotic components; presentation subsystems that present visual or audio information, e.g., screen displays, lights, and speakers; and communication subsystems that communicate information across one or more communications networks, to name just a few examples.

The control subsystems of the robot 400 include a locomotion subsystem 410. In this example, the locomotion system 410 has wheels and treads. Each wheel subsystem can be independently operated, which allows the robot to spin and perform smooth arcing maneuvers. In some implementations, the locomotion subsystem includes sensors that provide feedback representing how quickly one or more of the wheels are turning. The robot can use this information to control its position and speed.

The control subsystems of the robot 400 include an effector subsystem 420 that is operable to manipulate objects in the robot's environment. In this example, the effector subsystem 420 includes a lift and one or more motors for controlling the lift. The effector subsystem 420 can be used to lift and manipulate objects in the robot's environment. The effector subsystem 420 can also be used as an input subsystem, which is described in more detail below.

The control subsystems of the robot 400 also include a robot head 430, which has the ability to tilt up and down and optionally side to side. On the robot 400, the tilt of the head 430 also directly affects the angle of a camera 450.

The presentation subsystems of the robot 400 include one or more electronic displays, e.g., electronic display 440, which can each be a color or a monochrome display. The electronic display 440 can be used to display any appropriate information. In FIG. 1, the electronic display 440 is presenting a simulated pair of eyes that can be used to provide character-specific information. The presentation subsystems of the robot 400 also include one or more lights 442 that can each turn on and off, optionally in multiple different colors.

The presentation subsystems of the robot 400 can also include one or more speakers, which can play one or more sounds in sequence or concurrently so that the sounds are at least partially overlapping.

The input subsystems of the robot 400 include one or more perception subsystems, one or more audio subsystems, one or more touch detection subsystems, one or more motion detection subsystems, one or more effector input subsystems, and one or more accessory input subsystems, to name just a few examples.

The perception subsystems of the robot 400 are configured to sense light from an environment of the robot. The perception subsystems can include a visible spectrum camera, an infrared camera, or a distance sensor, to name just a few examples. For example, the robot 400 includes an integrated camera 450. The perception subsystems of the robot 400 can include one or more distance sensors. Each distance sensor generates an estimated distance to the nearest object in front of the sensor.

The perception subsystems of the robot 400 can include one or more light sensors. The light sensors are simpler electronically than cameras and generate a signal when a sufficient amount of light is detected. In some implementations, light sensors can be combined with light sources to implement integrated cliff detectors on the bottom of the robot. When light generated by a light source is no longer reflected back into the light sensor, the robot 400 can interpret this state as being over the edge of a table or another surface.

The audio subsystems of the robot 400 are configured to capture from the environment of the robot. For example, the robot 400 can include a directional microphone subsystem having one or more microphones. The directional microphone subsystem also includes post-processing functionality that generates a direction, a direction probability distribution, location, or location probability distribution in a particular coordinate system in response to receiving a sound. Each generated direction represents a most likely direction from which the sound originated. The directional microphone subsystem can use various conventional beam-forming algorithms to generate the directions.

The touch detection subsystems of the robot 400 are configured to determine when the robot is being touched or touched in particular ways. The touch detection subsystems can include touch sensors, and each touch sensor can indicate when the robot is being touched by a user, e.g., by measuring changes in capacitance. The robot can include touch sensors on dedicated portions of the robot's body, e.g., on the top, on the bottom, or both. Multiple touch sensors can also be configured to detect different touch gestures or modes, e.g., a stroke, tap, rotation, or grasp.

The motion detection subsystems of the robot 400 are configured to measure movement of the robot. The motion detection subsystems can include motion sensors and each motion sensor can indicate that the robot is moving in a particular way. For example, a gyroscope sensor can indicate a relative orientation of the robot. As another example, an accelerometer can indicate a direction and a magnitude of an acceleration, e.g., of the Earth's gravitational field.

The effector input subsystems of the robot 400 are configured to determine when a user is physically manipulating components of the robot 400. For example, a user can physically manipulate the lift of the effector subsystem 420, which can result in an effector input subsystem generating an input signal for the robot 400. As another example, the effector subsystem 120 can detect whether or not the lift is currently supporting the weight of any objects. The result of such a determination can also result in an input signal for the robot 400.

The robot 400 can also use inputs received from one or more integrated input subsystems. The integrated input subsystems can indicate discrete user actions with the robot 400. For example, the integrated input subsystems can indicate when the robot is being charged, when the robot has been docked in a docking station, and when a user has pushed buttons on the robot, to name just a few examples.

The robot 400 can also use inputs received from one or more accessory input subsystems that are configured to communicate with the robot 400. For example, the robot 400 can interact with one or more cubes that are configured with electronics that allow the cubes to communicate with the robot 400 wirelessly. Such accessories that are configured to communicate with the robot can have embedded sensors whose outputs can be communicated to the robot 400 either directly or over a network connection. For example, a cube can be configured with a motion sensor and can communicate an indication that a user is shaking the cube.

The robot 400 can also use inputs received from one or more environmental sensors that each indicate a particular property of the environment of the robot. Example environmental sensors include temperature sensors and humidity sensors to name just a few examples.

One or more of the input subsystems described above may also be referred to as “sensor subsystems.” The sensor subsystems allow a robot to determine when a user is interacting with the robot, e.g., for the purposes of providing user input, using a representation of the environment rather than through explicit electronic commands, e.g., commands generated and sent to the robot by a smartphone application. The representations generated by the sensor subsystems may be referred to as “sensor inputs.”

The robot 400 also includes computing subsystems having data processing hardware, computer-readable media, and networking hardware. Each of these components can serve to provide the functionality of a portion or all of the input and output subsystems described above or as additional input and output subsystems of the robot 400, as the situation or application requires. For example, one or more integrated data processing apparatus can execute computer program instructions stored on computer-readable media in order to provide some of the functionality described above.

The robot 400 can also be configured to communicate with a cloud-based computing system having one or more computers in one or more locations. The cloud-based computing system can provide online support services for the robot. For example, the robot can offload portions of some of the operations described in this specification to the cloud-based system, e.g., for determining behaviors, computing signals, and performing natural language processing of audio streams.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method performed by an agent, the method comprising:

receiving one or more sensor inputs from the one or more sensor subsystems;

computing, from the one or more sensor inputs, a prediction representing a likelihood of one or more users engaging with the agent over a particular subsequent time period;

determining that the computed prediction indicates that the agent is in an unengaged state;

in response, selecting one or more unengaged time computing tasks; and

performing the selected one or more unengaged time computing tasks.

Embodiment 2 is the method of embodiment 1, wherein the agent is a mobile robot having one or more physically moveable components.

Embodiment 3 is the method of any one of embodiments 1-2, wherein the unengaged time computing tasks comprise tasks received from a volunteer computing project host system.

Embodiment 4 is the method of any one of embodiments 1-3, wherein computing a prediction representing a likelihood of one or more users engaging with the agent over a particular subsequent time period comprises determining whether or not the sensor inputs indicate presence of one or more users.

Embodiment 5 is the method of any one of embodiments 1-4, wherein the unengaged time computing tasks comprise tasks that include downloading files over the Internet, organizing a collection of user files, or performing system maintenance tasks.

Embodiment 6 is the method of any one of embodiments 1-5, wherein performing the unengaged time computing tasks cause the agent to physically navigate around an environment of the agent to generate a map of the environment of the agent.

Embodiment 7 is the method of embodiment 6, wherein generating a map of the environment comprises determining boundaries within the environment of the robot.

Embodiment 8 is the method of embodiment 6, wherein performing the unengaged time computing tasks cause the agent to physically navigate around an environment of the agent to generate acoustic transfer functions of the environment of the agent.

Embodiment 9 is a method performed by an agent, the method comprising:

maintaining a volunteer computing status that represents whether or not the agent is participating in volunteer computing projects;

determining that the volunteer computing status represents that participating in volunteer computing projects is enabled;

in response, obtaining, from a volunteer computing project host computer system, one or more volunteer computing tasks;

determining, by the agent, that the agent is available to perform the one or more volunteer computing tasks;

performing the one or more volunteer computing tasks and providing one or more results to the volunteer computing project host computer system;

updating an emotion state of the agent by increasing one or more emotional aspects of the emotion state; and

selecting an action to perform based on the updated emotion state of the agent.

Embodiment 10 is the method of embodiment 9, wherein the agent is a mobile robot having one or more physically moveable components.

Embodiment 11 is the method of any one of embodiments 9-10, wherein selecting an action to perform comprises presenting information representing results of the one or more volunteer computing tasks.

Embodiment 12 is the method of any one of embodiments 9-11, wherein selecting an action to perform comprises selecting an animation to perform based on the updated emotion state of the agent.

Embodiment 13 is the method of any one of embodiments 9-12, wherein the action to perform is an unlocked action that was unavailable before the one or more volunteer computing tasks were performed.

Embodiment 14 is the method of any one of embodiments 9-13, where the agent is a mobile robot having one or more physically moveable components.

Embodiment 15 is the method of any one of embodiments 9-14, wherein the operations further comprise:

receiving, by the agent from a project distribution system, project information for participating in a volunteer computing project, wherein the project information specifies one or more of a plurality of volunteer computing projects curated by the project distribution system;

using the received project information to install one or more software packages on the agent; and

performing the one or more volunteer computing tasks using the one or more software packages installed on the agent.

Embodiment 16 is the method of any one of embodiments 9-15, wherein determining that the agent is available to perform the one or more volunteer computing tasks comprises using one or more sensor subsystems to determine that no users have been detected for at least a threshold period of time.

Embodiment 17 is the method of any one of embodiments 9-16, wherein the agent is a mobile robot and the operations further comprise navigating the robot back to a charging station before performing the one or more volunteer computing tasks.

Embodiment 18 is the method of any one of embodiments 9-17, wherein the operations further comprise:

identifying, by the agent, one or more auxiliary devices that are enabled to participate in one or more volunteer computing projects;

configuring, by the agent, the one or more auxiliary devices to participate in a volunteer computing project hosted by the volunteer computing project host computer system.

Embodiment 19 is the method of any one of embodiments 9-18, wherein the operations further comprise:

further updating the emotion state of the agent by modifying one or more emotional aspects of the emotion state in response to configuring one or more auxiliary devices to participate in the volunteer computing project hosted by the volunteer computing project host computer system.

Embodiment 20 is an agent comprising: one or more processors, one or more sensor subsystems, and one or more storage devices storing instructions that are operable, when executed by the one or more processors, to cause the agent to perform the method of any one of embodiments 1 to 19.

Embodiment 21 is the agent of embodiment 20, wherein the agent is a mobile robot having one or more physically moveable components.

Embodiment 22 is a computer storage medium encoded with a computer program, the program comprising instructions that are operable, when executed by an agent comprising one or more processors and one or more sensor subsystems, cause the agent to perform the method of any one of embodiments 1 to 19.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A robot comprising:
one or more processors;
one or more sensor subsystems;
one or more storage devices storing instructions that are operable, when executed by the one or more processors, to cause the robot to perform operations comprising:
receiving one or more sensor inputs from the one or more sensor subsystems;
computing, from the one or more sensor inputs, a prediction representing a likelihood of one or more users engaging with the robot over a particular subsequent time period;
determining that the computed prediction indicates that the robot is in an unengaged state;
in response, selecting one or more unengaged time computing tasks; and
performing the selected one or more unengaged time computing tasks.

2. The robot of claim 1, wherein the mobile robot has one or more physically moveable components.

3. The robot of claim 1, wherein the unengaged time computing tasks comprise tasks received from a volunteer computing project host system.

4. The robot of claim 1, wherein computing a prediction representing a likelihood of one or more users engaging with the robot over a particular subsequent time period comprises determining whether or not the sensor inputs indicate presence of one or more users.

5. The robot of claim 1, wherein the unengaged time computing tasks comprise tasks that include downloading files over the Internet, organizing a collection of user files, or performing system maintenance tasks.

6. The robot of claim 1, wherein performing the unengaged time computing tasks cause the robot to physically navigate around an environment of the robot to generate a map of the environment of the robot.

7. The robot of claim 6, wherein generating a map of the environment comprises determining boundaries within the environment of the robot.

8. The robot of claim 6, wherein performing the unengaged time computing tasks cause the robot to physically navigate around an environment of the robot to generate acoustic transfer functions of the environment of the robot.

9. A character-driven agent comprising:
one or more processors; and
one or more storage devices storing instructions that are operable, when executed by the one or more processors, to cause the agent to perform operations comprising:
maintaining a volunteer computing status that represents whether or not the agent is participating in volunteer computing projects;
determining that the volunteer computing status represents that participating in volunteer computing projects is enabled;
in response, obtaining, from a volunteer computing project host computer system, one or more volunteer computing tasks;
determining, by the agent, that the agent is available to perform the one or more volunteer computing tasks;
performing the one or more volunteer computing tasks and providing one or more results to the volunteer computing project host computer system;
updating an emotion state of the agent by increasing one or more emotional aspects of the emotion state; and
selecting an action to perform based on the updated emotion state of the agent.

10. The agent of claim 9, wherein the agent is a mobile robot having one or more physically moveable components.

11. The agent of claim 9, wherein selecting an action to perform comprises presenting information representing results of the one or more volunteer computing tasks.

12. The agent of claim 9, wherein selecting an action to perform comprises selecting an animation to perform based on the updated emotion state of the agent.

13. The agent of claim 9, wherein the action to perform is an unlocked action that was unavailable before the one or more volunteer computing tasks were performed.

14. The agent of claim 9, where the agent is a mobile robot having one or more physically moveable components.

15. The agent of claim 9, wherein the operations further comprise:
receiving, by the agent from a project distribution system, project information for participating in a volunteer computing project, wherein the project information specifies one or more of a plurality of volunteer computing projects curated by the project distribution system;
using the received project information to install one or more software packages on the agent; and
performing the one or more volunteer computing tasks using the one or more software packages installed on the agent.

16. The agent of claim 9, wherein determining that the agent is available to perform the one or more volunteer computing tasks comprises using one or more sensor subsystems to determine that no users have been detected for at least a threshold period of time.

17. The agent of claim 9, wherein the agent is a mobile robot and the operations further comprise navigating the robot back to a charging station before performing the one or more volunteer computing tasks.

18. The agent of claim 9, wherein the operations further comprise:
identifying, by the agent, one or more auxiliary devices that are enabled to participate in one or more volunteer computing projects;
configuring, by the agent, the one or more auxiliary devices to participate in a volunteer computing project hosted by the volunteer computing project host computer system.

19. The agent of claim 9, wherein the operations further comprise:
further updating the emotion state of the agent by modifying one or more emotional aspects of the emotion state in response to configuring one or more auxiliary devices to participate in the volunteer computing project hosted by the volunteer computing project host computer system.

20. An agent comprising:
one or more processors;
one or more sensor subsystems;
one or more storage devices storing instructions that are operable, when executed by the one or more processors, to cause the agent to perform operations comprising:
receiving one or more sensor inputs from the one or more sensor subsystems;
computing, from the one or more sensor inputs, a prediction representing a likelihood of one or more users engaging with the agent over a particular subsequent time period;
determining that the computed prediction indicates that the agent is in an unengaged state;
in response, selecting one or more unengaged time computing tasks; and
performing the selected one or more unengaged time computing tasks.
